(19) United States
(12) Patent Application Publication
(10) Pub. No.: US 2012/0303761 A1
(43) Pub. Date: Nov. 29, 2012

(54) BREAKPOINT CONTINUOUS TRANSMISSION METHOD

(76) Inventors: Hui WANG, Tianjin (CN); Chih-Feng CHEN, Taipei (TW)

(21) Appl. No.: 13/251,988

(22) Filed: Oct. 3, 2011

(30) Foreign Application Priority Data
May 24, 2011 (CN) 201110139651.5

(51) Int. Cl. G06F 15/16

(52) U.S. Cl. 709/219

(57) ABSTRACT

A method for breakpoint continuous transmission is applicable to the case that a server may continuously transmit data of which the transmission is not completed directly from a breakpoint when interruption of data transmission occurs, and may find out modified data during system interruption, thereby maintaining data consistency at entire data transmission time points. First, the server receives a data element to be transmitted and a first snapshot corresponding to the data element to be transmitted that are transmitted by a client. When detecting an interruption signal, the server determines whether the first snapshot of the client is complete. If the first snapshot of the client is not complete, the server first determines whether metadata of the data element to be transmitted of the client is changed, and if the metadata is changed, the server first finishes receiving the changed metadata, and then continues the transmission.

### CROSS-REFERENCE TO RELATED APPLICATIONS

This non-provisional application claims priority under 35 U.S.C. §119(a) on Patent Application No(s). 201110139651.5 filed in China, P.R.C. on May 24, 2011, the entire contents of which are hereby incorporated by reference.

### BACKGROUND OF THE INVENTION

1. Field of Invention

The present invention relates to a data transmission method, and more particularly to a method for continuously transmitting data from a breakpoint and maintaining data consistency when interruption of data transmission occurs.

2. Related Art

With the development of technology, more and more companies build a plurality of databases to execute business or management of the companies, and the databases are associated with each other and transmit data to each other, so as to maintain consistency of the databases. However, once power interruption or viral invasion occurs in the databases, which is sufficient to cause irrecoverable damage to data, the data internal to the company is always disordered or lost, thereby having severe impact on the operation of the entire company. Therefore, stable transmission and backup of the databases is rather important to the enterprise.

However, during data transmission or backup, when the data is not completely transmitted due to network interruption or a system fault, at this time, if a user intends to continue the data transmission, the user needs to transmit the data to a server from the beginning so as to complete the transmission, because the system does not record an interruption position. In this way, the data transmission time is prolonged and the cost is increased. In order to solve this problem, the industry develops a breakpoint continuous transmission method. In such method, the server may record a data breakpoint upon interruption of the transmission, and first read the data at the previously recorded breakpoint after the transmission returns to normal, and then continue transmitting the data of which the transmission is not completed directly from the breakpoint. Therefore, through such breakpoint continuous transmission technology, once the interruption of the data transmission occurs, the user is no longer required to retransmit the data from the beginning, thereby improving the data transmission efficiency and reducing the cost for the backup.

However, during the interruption of the data transmission, the user may continuously update data to the database. In this way, transmission time points and data content of the transmitted data and the data in continuous transmission are not consistent. Once the data needs to be recovered or used, not only the complexity of the data recovery is dramatically increased, but also error in the data content may be caused accordingly due to the different time points, so that the operation of the company is affected. Therefore, a method for maintaining consistency of all data time points and content during breakpoint continuous transmission is required in this field, so as to satisfy the consistency of all data during data transmission.

### SUMMARY OF THE INVENTION

Accordingly, the present invention is a method for enabling data of which the transmission is not completed to be continuously transmitted from a breakpoint when interruption of data transmission occurs, and enabling a server to determine whether the transmitted data is modified during system interruption and to further transmit the modified data.

In an embodiment of the present invention, a server receives a data element to be transmitted and a first snapshot corresponding to the data element to be transmitted. The server further determines whether the first snapshot of a client is complete when detecting an interruption signal, and if the first snapshot is complete, the server continues receiving the data element to be continuously transmitted of which the transmission is not completed from a breakpoint. If the first snapshot is not complete, the server may first determine whether metadata of the data element to be transmitted of the client is changed, and if the metadata is changed by a user, the server may first receive a data element corresponding to the metadata and store the data element in the server.

Through the method, not only the data of which the transmission is not completed is continuously transmitted from the breakpoint after the interruption of the data transmission occurs, but also it is determined whether an original snapshot of the user is complete before continuous transmission by taking the snapshot, and if the snapshot is not complete, it is further determined whether the user updates the data, thereby ensuring the completeness and consistency of the data to be transmitted.

### BRIEF DESCRIPTION OF THE DRAWINGS

The present invention will become more fully understood from the detailed description given herein below for illustration only, and thus are not imitative of the present invention, and wherein:

FIG. 1 is a schematic view of an internal structure of a system according to an embodiment of the present invention;

FIG. 2 is a flow chart of implementation of FIG. 1; and

FIG. 3 is a detailed flow chart of the implementation of FIG. 1.

### DETAILED DESCRIPTION OF THE INVENTION

The detailed features and advantages of the present invention are described below in great detail through the following embodiments, the content of which is sufficient for those of ordinary skill in the art to understand the technical content of the present invention and to implement the present invention accordingly. Based upon the content of the specification, the claims, and the drawings, those of ordinary skill in the art can easily understand the relevant objectives and advantages of the present invention.

The present invention provides a breakpoint continuous transmission method. The breakpoint continuous transmission refers to that, when interruption of data transmission occurs, a server may record a breakpoint of the transmission interruption, and when a user gives a data retransmission instruction, the server may first read the previously recorded breakpoint, and then retransmit the data from the breakpoint.

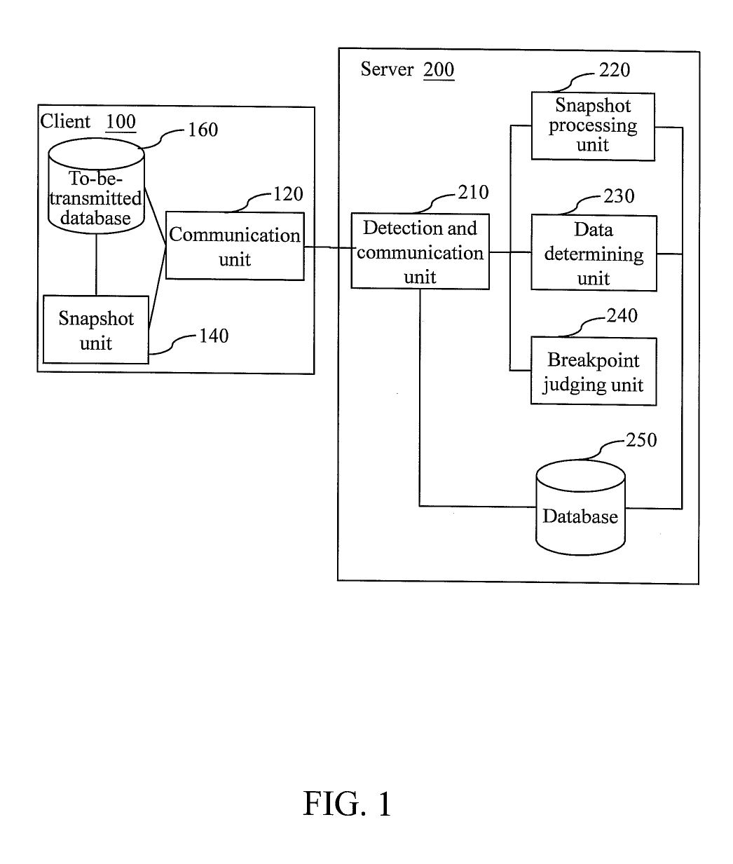

Referring to FIG. 1, a schematic view of an internal structure of a system according to an embodiment of the present invention is shown. A main implementation system of the method is located in a server 200, the server 200 is connected to a client 100 through an Internet, after the server 200 receives a data transmission request from the client 100, the server 200 receives the data transmitted by the client 100 so as to complete the method. The client 100 may be a physical system having a database and capable of using the Internet for connection such as a personal computer, a business computer, or a cell phone, and the client 100 may receive or transmit the data provided by the server 200 through the Internet. The server 200 may be a physical server and has a database capable of storing the data to be transmitted. The server 200 may receive information transmitted from the client 100 through the connection of the Internet, and the data that is completely received is stored in the corresponding database after being processed by the server 200.

As shown in FIG. 1, the client 100 has a communication unit 120, a snapshot unit 140, and a to-be-transmitted database 160 therein. The communication unit 120 is used to transmit a data transmission request sent by a user, and transmit data, a snapshot, and a request to the server 200 for processing, and receive and forward a processing result or request of other internal units to the server 200.

The snapshot unit 140 is used to take a snapshot and temporarily store the takent snapshot. The snapshot unit 140 may be combination of a processing unit in a central processing unit (CPU) and a processing unit in a memory.

The to-be-transmitted database 160 is a database for storing data to be transmitted, and is capable of storing various different data. The to-be-transmitted database 160 may be a hard disk or any hardware capable of storing data. The user may further access the to-be-transmitted database 160 through other management interfaces, such as a Structured Query Language (SQL) database developed by Microsoft or an ORACLE database developed by Oracle Corporation.

FIG. 1 further shows the internal architecture of the server 200. The server 200 has a detection and communication unit 210, a snapshot processing unit 220, a data determining unit 230, a breakpoint determining unit 240, and a database 250 therein.

The detection and communication unit 210 is used to receive the request, snapshot, or data transmitted from the communication unit 120 of the client 100, and distribute the received content to other units in the server 200 for processing. The detection and communication unit 210 may also transmit the request or data to the client 100 and detect whether an interruption signal exists.

The snapshot processing unit 220 may be used to create a directory tree of the data and an characteristic of the data according to the snapshot of the client 100. The snapshot processing unit 220 may determine whether the snapshot of the client 100 is complete when the detection and communication unit 210 receives a continuous transmission signal.

If the snapshot processing unit 220 determines that the snapshot in the client 100 is not complete, the snapshot processing unit 220 transmits an instruction to the data determining unit 230. The data determining unit 230 is used to determine whether metadata is changed, and if the metadata is changed, the data determining unit 230 sends a request for requesting the client 100 to transmit new data. The data determining unit 230 may be a processing unit of a CPU.

The breakpoint determining unit 240 is used to determine whether the data currently processed by the data determining unit 230 is breakpoint data. When detecting an interruption signal, the detection and communication unit 210 transmits breakpoint information to the breakpoint determining unit 240 and stores the breakpoint information. During the continuous transmission, after determining whether the metadata is changed, the data determining unit 230 transmits the data of the metadata to the breakpoint determining unit 240, and the breakpoint determining unit 240 determines whether the breakpoint is reached by comparing the data of the metadata with the previously stored breakpoint data.

The database 250 is used to store the received data, and the data transmitted from the client 100 that is received by the server 200 is stored in the database 250. In addition, when creating the directory tree and the characteristic according to the snapshot of the client 100, the snapshot processing unit 220 also creates the directory tree and the characteristic in the database 250. The database 250 may be a hard disk or any hardware capable of storing data.

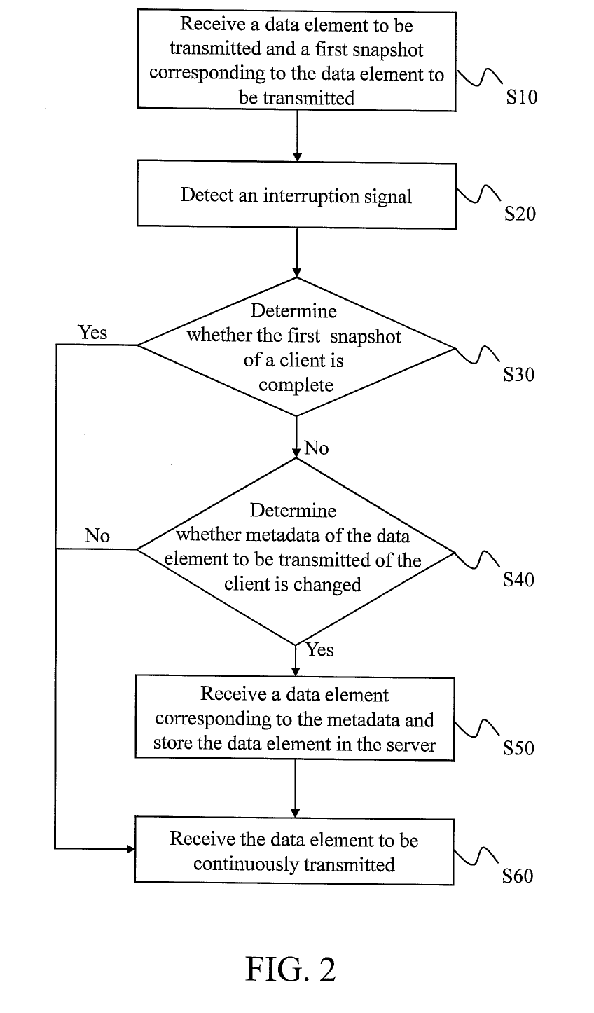

Referring to FIG. 2, a flow chart of implementation of FIG. 1 is shown. According to this embodiment, when a user gives a data transmission instruction through the client 100, the communication unit 120 transmits a data transmission request to the server 200, and after receiving the data transmission request transmitted from the communication unit 120, the detection and communication unit 210 of the server 200 begins to receive a data element to be transmitted and a first snapshot corresponding to the data element to be transmitted (S10) and stores them in the database 250.

The data element to be transmitted is data that the user intends to transmit to the server 200 for backup or processing, and before the data element to be transmitted is transmitted to the server 200, the snapshot unit 140 of the client 100 first takes snapshots of all data elements to be transmitted, and the communication unit 120 transmits the snapshots to the server 200.

When the transmission is interrupted, the detection and communication unit 210 detects an interruption signal (S20). In an embodiment, when receiving an interruption signal, the detection and communication unit 210 directly transmits a processing instruction to the snapshot processing unit 220.

In another embodiment, when receiving an interruption signal, the detection and communication unit 210 waits until a continuous transmission instruction given by a user is received, and then transmits a processing instruction to the snapshot processing unit 220. The snapshot processing unit 220 determines whether the first snapshot of the client 100 is complete (S30) after receiving the processing instruction.

In an embodiment, the method for determining whether the first snapshot is complete by the snapshot processing unit 220 may be as follows: the snapshot processing unit 220 sends a determining request to the snapshot unit 140 for requesting the snapshot unit 140 to transmit a reply, and then makes determination according to the reply.

In another embodiment, before transmitting a continuous transmission instruction given by the user, the communication unit 120 first transmits a determining instruction to the snapshot unit 130, and then transmits the continuous transmission instruction and a reply of the snapshot unit simultaneously to the server 200 after receiving the reply of the snapshot unit 130, and then the snapshot processing unit 220 can make determining according to the reply transmitted from the client 100.

If the snapshot processing unit 220 determines that the first snapshot is not complete, the server 200 first determines whether metadata of the data element to be transmitted of the client 100 is changed (S40). The snapshot processing unit 220 transmits a data determining instruction to the data determining unit 230, and the data determining unit 230 reads the received data element in the database 250 after receiving the instruction, compares the data element in the database 250 with the data element of the client 100, and further determines whether the data is changed during the interruption by comparing to see whether the metadata and an characteristic of the data element to be transmitted are consistent with the metadata and an characteristic of the received data element.

When the metadata is changed, the server 200 receives a data element corresponding to the metadata and stores the data element in the server 200 (S50). The data determining unit 230 sends a retransmission request through the detection and communication unit 210, and after receiving the retransmission request, the communication unit 120 searches for and reads the data element to be retransmitted in the to-be-transmitted database 160, and transmits the data element to the server 200. Finally, the server 200 continues receiving the data element to be continuously transmitted (S60) and stores the data element in the database 250.

In the foregoing steps of executing the method of the present invention, when the steps are executed midway or the continuous transmission is performed midway, the data transmission may be interrupted again. If the re-interruption of the data transmission occurs, the steps may be repeatedly executed many times. The present invention is not limited by the number of times the method is executed.

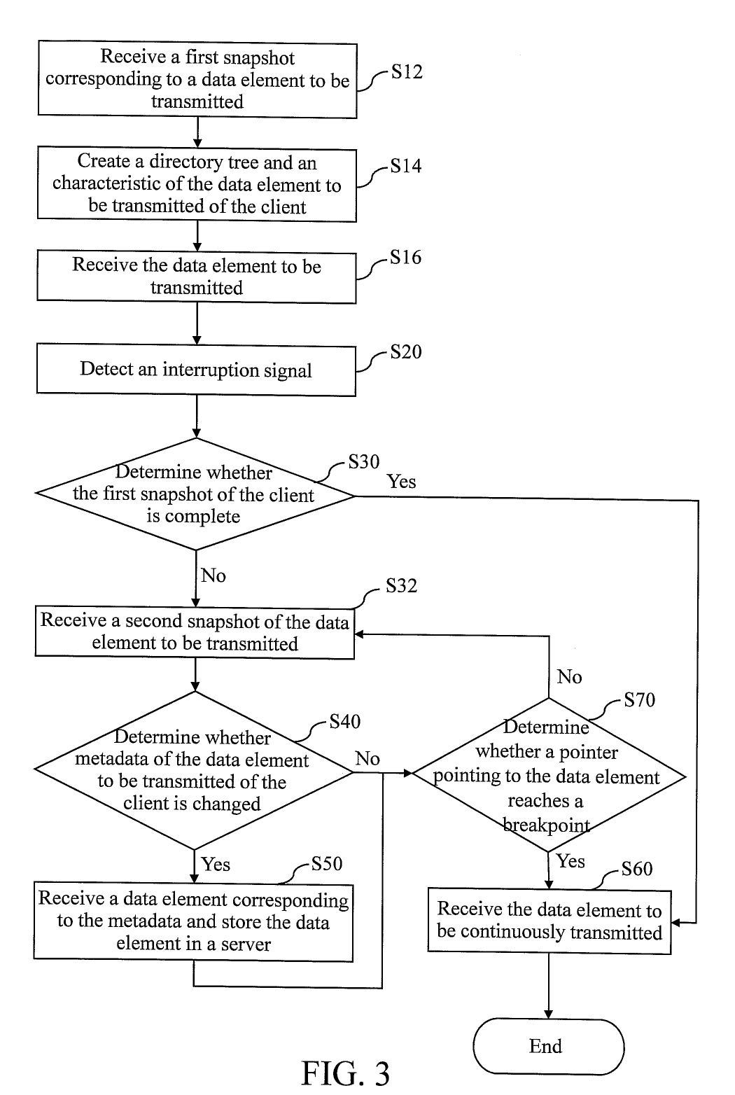

As shown in FIG. 3, in an embodiment, the step of receiving the data element to be transmitted and the first snapshot corresponding to the data element to be transmitted (S10) may be divided into the following three more detailed steps. First, the detection and communication unit 210 of the server 200 receives a first snapshot corresponding to a data element to be transmitted (S12), and when receiving the first snapshot, the detection and communication unit 210 transmits the first snapshot to the snapshot processing unit 220. When receiving the first snapshot, the snapshot processing unit 220 creates a directory tree and an characteristic of the data element to be transmitted of the client 100 in the database 250 according to content of the first snapshot (S14). After the operations are completed, the detection and communication unit 210 may begin to receive the data element to be transmitted (S16) and store the data element in the database 250.

In addition, in FIG. 3, when the snapshot processing unit 220 determines that the first snapshot is not complete, a second snapshot of the data element to be transmitted needs to be received (S32). When the first snapshot is not complete, the snapshot processing unit 220 sends a snapshot retransmission request to the snapshot unit 140 of the client 100 through the detection and communication unit 210. When receiving the request, the snapshot unit 140 transmits the new second snapshot to the server 200, and the snapshot processing unit 220 processes the second snapshot.

The difference between the first snapshot and the second snapshot lies in that, time points of taking the second snapshot and the first snapshot are different, the shot data may be the same or different, and the second snapshot and the first snapshot respectively represent states of data at different time points.

In this embodiment, before the step of receiving the data element to be continuously transmitted (S60) is executed, it is first determined whether a pointer pointing to the data element reaches a breakpoint (S70). When the data determining unit 230 finishes the determination, whatever the determination result is, the data determining unit 230 transmits the pointer pointing to the data element to the breakpoint determining unit 240. The breakpoint determining unit 240 determines whether the pointer pointing to the data element reaches the breakpoint at which the last transmission stops, in other words, whether the data element to which the pointer points is the breakpoint of the last transmission. If the data determining unit 230 determines that the data element to which the pointer currently points is not the breakpoint, the process returns to the step of determining whether the metadata of the data element to be transmitted of the client 100 is changed (S40), and the subsequent steps are re-executed.

When the data determining unit 230 determines that the position to which the pointer currently points is the breakpoint, the data determining unit 230 sends a continuous transmission instruction to the detection and communication unit 210, and the detection and communication unit 210 sends the request to the client 100, and then, a file of which the transmission is not completed may be continuously transmitted.

The structure of the foregoing metadata at least comprises a file's creation time, a file's last modification time, and a file's last access time. The structure of the metadata is not limited to the content of the present invention, and may be modified according to the actual requirements of the client 100.

What is claimed is:

1. A breakpoint continuous transmission method, comprising:
receiving a data element to be transmitted and a first snapshot corresponding to the data element to be transmitted;
detecting an interruption signal;
determining whether the first snapshot of a client is complete; and
when the first snapshot is not complete, executing the following steps:
determining whether a metadata of the data element to be transmitted of the client is changed; and
receiving the data element corresponding to the metadata and storing the data element in a server, when the metadata is changed; and
receiving a data element to be continuously transmitted.

2. The breakpoint continuous transmission method according to claim 1, wherein the step of receiving the data element to be transmitted and the first snapshot corresponding to the data element to be transmitted comprises:
receiving the first snapshot corresponding to the data element to be transmitted;
creating a directory tree and an characteristic of the data element to be transmitted of the client; and
receiving the data element to be transmitted.

3. The breakpoint continuous transmission method according to claim 1, wherein the step of determining whether the first snapshot of the client is complete comprises:
receiving a second snapshot of the data element to be transmitted, when the first snapshot is not complete.

4. The breakpoint continuous transmission method according to claim 1, wherein before the step of receiving the data element to be continuously transmitted, the breakpoint continuous transmission method further comprises:
determining whether a pointer pointing to the data element reaches a breakpoint; and
re-executing the steps that are executed when the first snapshot is not complete, when the pointer does not reach the breakpoint.

5. The breakpoint continuous transmission method according to claim 1, wherein a structure of the metadata comprises a file's creation time, a file's last modification time, and a file's last access time.

6. The breakpoint continuous transmission method according to claim 1, wherein in the step of receiving the data element to be continuously transmitted, the data element is received from the breakpoint.
